(19) United States
(12) Patent Application Publication
(10) Pub. No.: US 2017/0355239 A1
(43) Pub. Date: Dec. 14, 2017

(54) Wheel Suspension Trailing Arm and Method Making Same

(71) Applicant: Ford Global Technologies, LLC, Dearborn, MI (US)

(72) Inventors: Rainer Souschek, Aachen (DE); Freidrich Peter Wolf-Monheim, Aachen (DE); Thomas Gerhards, Niederzier (DE); Ralf Hintzen, Aachen (DE); Daniel Mainz, Herzogenrath (DE); Paul Zandbergen, Würselen (DE); Nicole Zandbergen, Würselen (DE); Alberto Girelli Consolaro, Aachen (DE)

(73) Assignee: Ford Global Technologies, LLC, Dearborn, MI (US)

(21) Appl. No.: 15/616,098

(22) Filed: Jun. 7, 2017

(30) Foreign Application Priority Data
Jun. 8, 2016 (DE) DE102016210074.2

(51) Int. Cl. B60G 3/02; B29C 70/32; B29K 105/10; B29L 31/30; B29K 67/00

(52) U.S. Cl. CPC B60G 3/02; B29C 70/32; B29K 2067/00; B60G 2206/85; B60G 2206/7101; B29L 2031/30; B29K 2105/108

(57) ABSTRACT

A wheel suspension unit of a motor vehicle, for example a trailing arm, the trailing arm produced, at least in part, from a fiber-reinforced plastic. The trailing arm including a molded member or tube formed of braided and/or wound continuous fibers. The continuous fibers of the molded member or tube interlinked with a plastic matrix. The shape of the molded member or tube predefines the basic shape of the trailing arm with the trailing arm being of a curved and/or angled design

### CROSS-REFERENCE TO RELATED APPLICATIONS

Not Applicable.

### BACKGROUND OF THE INVENTION

### 1. Field of the Invention

The invention relates generally to a motor vehicle wheel suspension; and more specifically a trailing arm having a first end for attachment to the vehicle and a second end for connection to a wheel carrier, the trailing arm being produced, at least in part, from a fiber-reinforced plastic.

### 2. Description of Related Art

A motor vehicle suspension may include a trailing arm. The trailing arm can be pivotally connected on one end to the vehicle frame, a sub-frame or the vehicle body. The trailing arm connected on the opposite end to a wheel carrier used for supporting a wheel. Typically, a transverse control arm is pivotally connected to the wheel carrier and acts on the wheel carrier. Besides these pivoting configurations, there are some designs in which the trailing arm is fixedly connected to the vehicle frame, and by virtue of a given elasticity enables a movement of the wheel carrier connected thereto. The wheel carrier may be fixed to a cross member, not directly connected to the trailing arm, that connects the opposing trailing arms together.

Trailing arms are from sheet steel. For example, a sheet metal forming process forms a blade-shaped trailing arm. In addition, the sheet metal forming process may also form reinforcing elements.

Various demands are placed on the trailing arm, however, which cannot readily be met by a component formed from sheet steel. For one thing, the trailing arm should be as rigid as possible in a longitudinal direction, in order to absorb the torsional forces that occur in braking and acceleration processes. However, the wheel carrier connected to the trailing arm is normally suspended by multiple lateral connections (transverse control arms etc.), resulting in a kinematic redundancy. The trailing arm should therefore not be rigid in response to a vertical movement of the wheel in a transverse direction or torsionally rigid, since a certain flexibility is necessary in order to resolve the redundancy. In sheet-steel trailing arms, however, this flexibility leads to undamped oscillations at low-frequencies, which is undesirable from various NVH (noise/vibration/harshness) aspects. Furthermore, the weight of a sheet-steel component is undesirably high, in view of the current trend towards weight-saving and an associated reduction in fuel consumption.

The use of trailing arms made from a fiber-reinforced plastic has already been proposed. Further, multiple different plastics and/or different fibers may be used.

Although the known fiber-reinforced vehicle suspension links fulfil their function, the production of fiber-reinforced trailing arms, in particular, nevertheless offers scope for improvements.

### SUMMARY OF THE INVENTION

A vehicle wheel suspension including an elongated continuously extending beam having a first end, a second end, and a curved portion between said first end and said second end. The beam formed in part, of a molded tube of braided or wound continuous fibers, the continuous fibers of the molded tube interlinked with a plastic matrix wherein the shape of the molded tube predefines a shape of said beam.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a wheel suspension unit according to the prior art.

FIG. 2 is a schematic representation of the manufacture of a molded member or tube for a trailing arm.

FIG. 3 is a schematic representation illustrating various shapes, in particular various exemplary sections, taken along lines A-A of FIG. 3, of a molded member or tube for a trailing arm.

### DETAILED DESCRIPTION OF THE PREFERRED EMBODIMENTS

The following description of the preferred embodiment(s) is merely exemplary in nature and is in no way intended to limit the invention, its application, or uses. In the different figures the same parts are always provided with the same reference numerals, for which reason these are generally also described only once.

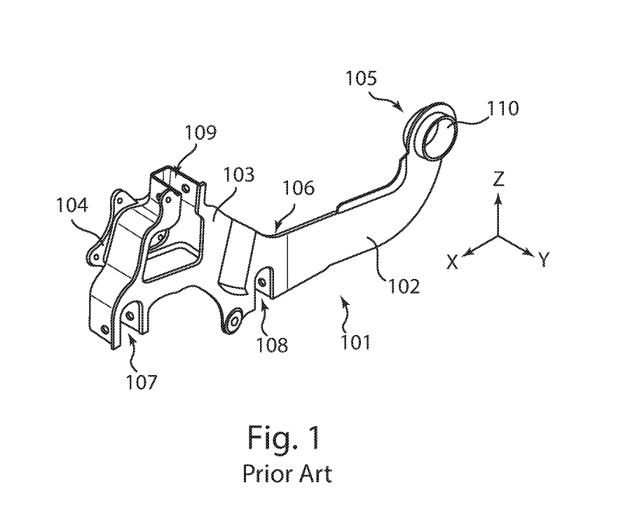

Turning to FIG. 1, there is shown a prior art embodiment of an L-shaped trailing arm 102 in the form of a control blade. The trailing arm 102 is part of a wheel suspension unit 101, the basic construction of which is known from the state of the art. The wheel suspension unit 101 substantially comprises three separately produced components: the trailing arm 102, a wheel carrier 103 and a brake carrier plate 104. The trailing arm 102 is formed as a substantially L-shaped component. A first end 105 has a mounting sleeve 110 for a rubber bushing, for attaching the trailing arm 102 to the chassis of a vehicle (not shown).

The trailing arm 102 connects to the wheel carrier 103 at a second end 106. The wheel carrier 103 has axle mountings 107, 108 and 109 for various laterally acting suspension links or arms. The brake carrier plate 104 is laterally attached to the wheel carrier 103.

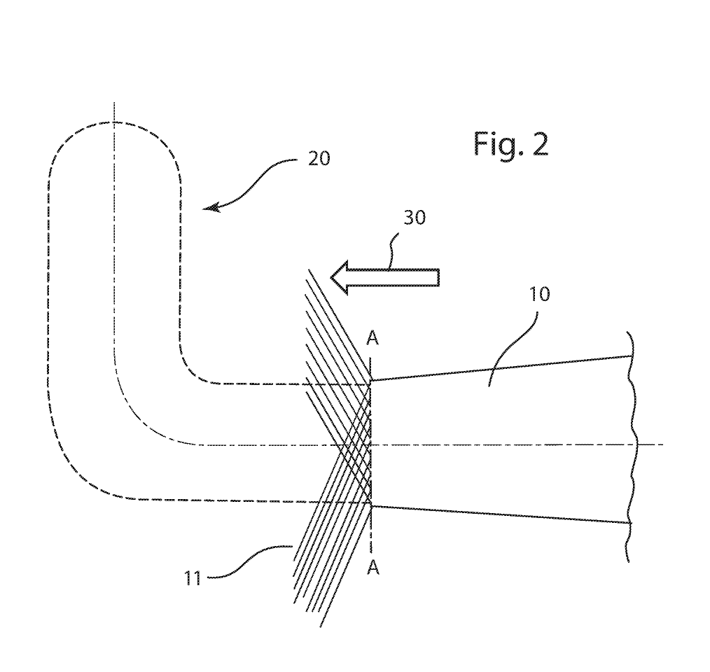

FIG. 2 it is a schematic representation of a manufacture of a molded member or tube 10 for use in a fiber-reinforced trailing arm. The shape of the molded member or tube 10 predefined by a winding core 20, sometimes referred to as a winding mandrel, represented by a dashed line. The winding core 20 is, in particular, an L-shaped component, so that an L-shaped molded member or tube 10 is produced. In the winding process a plurality of continuous fibers 11 is wound onto the winding core 20 at various angles. The winding direction 30 is identified by an arrow in FIG. 2.

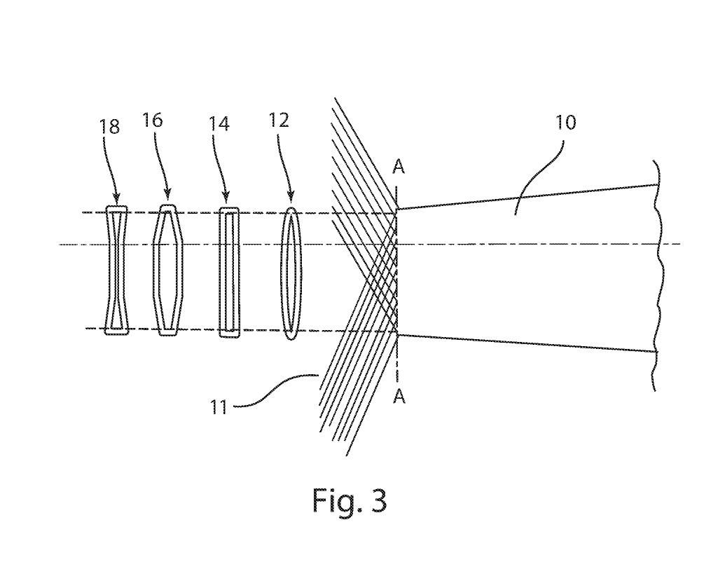

FIG. 3 shows various shapes of the cross section A-A of the molded member or tube 10, that can be produced in the winding process through a corresponding choice of winding core. The cross-sectional shape of the molded member or tube 10 may have an oval shape 12, a rectangular shape with rounded corners 14, a polygonal shape with rounded corners 16, and a constricted rectangular or polygonal shape 18. As illustrated with the constricted rectangular or polygonal shape 18, the distance between the opposing longer sides is smaller than the length of the shorter sides, resulting in the longer sides having a concave shape.

The geometry, that is the cross-sectional shape, of the molded member or tube 10 can be produced in various ways. In one embodiment, for example, a core is used, the core can be inflated to the specific dimensions and geometries. In particular, the molded member or tube 10 is first wound in a generic or general shape, after which the core is then inflated into the desired shape of the molded member or tube 10. For example, for constricted rectangular or polyvinyl shape 18, a molded member or tube 10 having a rectangular or polygonal cross section is first wound, then the core is inflated wherein the molded member or tube 10 so that it expands, for example, on the short sides of the wound molded member or tube 10 to create the desired geometry.

In an alternative embodiment, the wound molded member or tube 10 is externally impressed with a profile, in order to bring it into a specific shape. For example, a predetermined or desired profile may be applied externally and act on the molded member or tube 10 to compress or constrict the generic rectangular shape in the middle to create the constricted rectangular or polyvinyl shape 18. In addition, or alternatively, a vacuum can also be used for this purpose, serving to draw specific areas of the molded member or tube 10 inwards. An inflatable or compressible core may be used.

Using a wet state deformable matrix material is advantageous for shaping a winding core because the matrix material is deformable in a wet state. This matrix core can thus be compressed or inflated. The fiber winding direction can likewise be used to influence the shape of the molded member or tube 10. In particular, it is possible to select a specific internal tension between the longitudinal and the transverse direction.

The molded member or tube 10 is formed, at least in part, from a fiber-reinforced plastic. In one exemplary embodiment, molded member or tube 10 includes braided and/or wound continuous fibers, the continuous fibers of the molded member or tube 10 interlinked with a plastic matrix. Glass, aramid and/or carbon fibers, for example, may be used as fibers, it also being possible to mix different fiber materials. A polyester resin may be used as matrix material.

Using the molded member or tube 10 enables manufacture of fiber-reinforced composite trailing arms in various forms. In contrast to comparable vehicle suspension links, the trailing arm has the known advantage of weight-saving. The molded member or tube 10 makes it possible to predefine various trailing arm shapes, which are then molded with a plastic matrix to the frame side member. Other loose fibers can optionally be incorporated into this plastic matrix. Here the molded member or tube 10 interlinked with matrix material may enclose an internal cavity, so that the frame side member is a hollow component. The space inside the molded member or tube 10 may also be filled with material. This material may likewise be interlinked with the fibers of the member or tube 10, or not. For example, the space inside the member or tube 10 may be filled with a plastic, a fiber-reinforced plastic or some other material.

In this way, it is possible to manufacture a lightweight trailing arm in different shapes and with various connecting elements, producing different designs of the trailing arm by using different preformed molded members or tubes 10. The shape of the molded member or tube 10 defines the basic shape of the trailing arm. The trailing arm is thereby of a curved and/or angled design form. In an exemplary embodiment, the arm is an L-shaped trailing arm. In the case of an L-shaped trailing arm, for example, a molded member or tube 10 wound in an L-shape is used.

The chosen cross-sectional shape of the molded member or tube 10 may also vary widely. For example, the molded member or tube 10 in cross section may have a circular, oval, rectangular and/or polygonal shape. In the case of rectangular or polygonal shapes, the braided or wound molded member or tube 10 having continuous fibers can typically make the “corners” slightly rounded. At the same time the cross-sectional shape of the molded member or tube 10 may also vary over the length of the trailing arm, so that the molded member or tube 10 may have different shapes in different areas. By using such a molded member or tube 10, a trailing arm design can be freely selected anywhere between tubular and flat according to the intended application and the requirements.

The shape of the molded member or tube 10 can be produced through the winding/braiding of the molded member or tube 10 about a winding mandrel or core, having a corresponding shape. Performance of the winding or braiding operation may be computer and/or robot-assisted. The operation may include winding continuous fibers around the winding mandrel by laying them one on top of another so as to produce a braided or wound molded member or tube 10. The continuous fibers used are either already impregnated with matrix material prior to the winding operation, wherein the material cures together with the fibers, or the braided or wound molded member or tube 10 is then impregnated with matrix material, which then cures. Hybrid forms of these processes are also possible.

Various types of winding mandrels may be used. For example, the winding core or mandrel 20 may involve a temporary core, formed from sand and then removed after producing the molded member or tube 10. The winding core or mandrel 20 may also be a solid core; however, rigid or flexible cores are also contemplated. In an alternative embodiment, the winding mandrel or core 20 can be inflated to the specific dimensions and geometries. Such a winding mandrel or core 20 can advantageously be used for different geometries of a core. In particular, it can be used for geometries with a waist or concave contour.

The shape of the molded member or tube 10 may include connection points; for example, when the molded member or tube 10 forms a trailing arm the trailing arm may include connection points for connecting the trailing arm to other components of the motor vehicle formed on the trailing arm, in particular in the molded member or tube 10. For example, a bushing for attaching a trailing arm to a vehicle may be formed at a first end of the trailing arm. This bushing may already be provided as an opening in the molded member or tube 10. It may furthermore be incorporated into the molded member or tube 10 as a separate plastic component. This integrated bushing replaces steel or aluminum bushings, which are often used in the state of the art.

A component composed of another material, in particular metal, ceramic, rubber or another plastic, may be embedded into an area of molded member or tube 10, for example, in the trailing arm. This integrated component can be used to stabilize the trailing arm. In particular, the component may be a winding or braiding mandrel, used for manufacturing the molded member or tube 10. For example, the same plastic may be used for the winding core as is used for the matrix material, so that the core can optionally remain in the molded member or tube 10. The core of matrix material may additionally contain loose fibers and may be pressed to form a core of the required shape, for example.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle wheel suspension comprising:
an elongated continuously extending beam having a first end, a second end, and a curved portion between said first end and said second end;
said beam formed in part, of a molded tube of braided or wound continuous fibers, said continuous fibers of the molded tube interlinked with a plastic matrix wherein the shape of the molded tube predefines a shape of said beam.

2. The vehicle wheel suspension of claim 1 wherein the molded tube has a cross-sectional shape that varies over a length of the beam.

3. The vehicle wheel suspension of claim 1 including an additional component, other than said plastic matrix, embedded into said beam.

4. The vehicle wheel suspension of claim 1 including a core disposed in a hollow portion of said tube.

5. The vehicle wheel suspension of claim 4 wherein said core is formed of the same plastic matrix as the beam.

6. A wheel suspension unit of a motor vehicle comprising:
a trailing arm having a first end for attachment to the vehicle and a second end for connection to a wheel carrier, the trailing arm formed, at least in part, from a fiber-reinforced plastic;
the trailing arm formed, at least in part, of a molded member of braided or wound continuous fibers, the continuous fibers of the molded member being interlinked with a plastic matrix, and the shape of the molded member predefining the basic shape of the trailing arm wherein the trailing arm has a curved or angled design.

7. The wheel suspension unit of claim 6 wherein the molded member has a cross section having a circular, oval, rectangular, or polygonal shape.

8. The wheel suspension unit of claim 7 wherein the cross-sectional shape of the molded member varies over the length of the trailing arm.

9. The wheel suspension unit of claim 1 including a bushing for attaching the trailing arm to the vehicle formed at the first end of the trailing arm.

10. The wheel suspension unit of claim 1 including at least one component, composed of another material other than said plastic matrix, embedded into an area of the plastic of the trailing arm.

11. The wheel suspension unit of claim 10 wherein said at least one component is a core used for manufacturing the molded member.

12. A method for producing a suspension member of a motor vehicle comprising the steps of:
providing a pre-shaped winding core;
winding a plurality of continuous fibers onto said core; and
interlinking the continuous fibers with a matrix material;
removing said core to provide said suspension member with an internal cavity such that said suspension member is a hollow component.

13. The method set forth in claim 12 wherein the continuous fibers are wound onto the core at various angles.

14. The method as set forth in claim 12 wherein said pre-shape winding core is a generic shape producing a molded member or two having a rectangular or polyvinyl cross-section; and
inserting a core into the hollow portion of said molded member and said core to create a predetermined geometry.

15. The method as set forth in claim 11 wherein the space inside the molded member may be filled with material.

16. The method as set forth in claim 11 wherein the core remains in the molded member.
